(19) United States
(12) Patent Application Publication
(10) Pub. No.: US 2015/0235231 A1
(43) Pub. Date: Aug. 20, 2015

(54) Systems and Methods for Electronic Vehicle Licensing

(71) Applicant: Friday Michael, Abuja (NG)

(72) Inventor: Friday Michael, Abuja (NG)

(21) Appl. No.: 14/182,199

(22) Filed: Feb. 17, 2014

(51) Int. Cl. G06Q 30/00; G06Q 50/26

(52) U.S. Cl. CPC G06Q 30/018; G06Q 50/26

(57) ABSTRACT

A mobile vehicle electronic licensing terminal and an operating method thereof for supporting vehicle related transactions between a motorist and a motor vehicle administration authority.

This application claims priority to U.S. Provisional Application No. 61/765,128 filed Feb. 15, 2013.

### TECHNICAL FIELD

The present invention relates to an electronic vehicle licensing system and an operating method thereof for supporting motor vehicle transactions between a remote in-car or electronic vehicle licensing terminal and a local vehicle licensing authority as well as law enforcement transactions involving vehicles.

### BACKGROUND ART

An electronic vehicle licensing terminal can be configured to perform various functions. Examples of such functions is to provide licensing for vehicle users, to recall to recall data, date, and all information stored therein to enable the validation and authentication of vehicle license, to interact with Electronic Control Unit (ECU) of the vehicle to deactivate the ECU board system after expiration of the license, to monitor the date covered and date left for the user to enable him facilitate renewal before expiration, to give close to expiration notification, to communicate with local law enforcement system and to interface with the user's vehicle licensing account at the motor vehicle administration office so that a user get's electronic notification of the pendency of any other matters at the licensing office.

Such an electronic vehicle licensing system may be stand alone or integrated into the vehicle's electronics or navigation system, and have such other functions including data and voice communication function, a function of capturing still or moving images through a vehicle's camera, a voice storage function, a function of reproducing music files through a speaker system, a function of displaying image of video files.

Additionally, the vehicle licensing terminal may include an additional function for playing games, and may be implemented as a multimedia player. Moreover, the vehicle electronic licensing system can be integrated in a vehicle electronic terminal that can receive broadcast or multicast signals, allowing the user to view video or TV programs.

Preferably, the mobile vehicle electronic licensing terminal has a touch function to allow even users who are unskilled in a button/key input to use a touch screen to conveniently perform the operation of the terminal.

In general, the vehicle licensing terminal can perform wireless communication using a single baseband chipset (controller or processor) and a radio frequency (RF) unit.

Various identification modules, such as, user identity module (UIM), vehicle identity module (VIM), universal vehicle identity module (UVIM), and the like, are used to authenticate the user's usage authority and vehicle licensing information. The identification module is connected to a mobile vehicle electronic licensing terminal through a port. Among them, for the VIM is a device for storing personal information and vehicle licensing information to provide various services such as authentication, vehicle security, and other functions. In a vehicle licensing terminal employing a single VIM, there is used one VIM, which is connected to one processor.

### SUMMARY OF THE INVENTION

Accordingly, an object of the present invention is to provide a mobile vehicle electronic licensing terminal and an operating method thereof for supporting vehicle related transactions between a motorist and a motor vehicle administration authority.

Another object of the present invention is to provide a mobile vehicle electronic licensing terminal, and an operating method thereof for performing licensing renewal remotely and electronically communicating with the motor vehicle administration authority.

Another object of the present invention is to provide a vehicle electronic licensing terminal, and an operating method thereof for interfacing with law enforcement authority to provide vehicle licensing, insurance, emissions, and other law enforcement information such as unpaid tickets, notifications, violations, substance abuse violations, restrictions, and the like.

Another object of the present invention is to provide a vehicle electronic licensing terminal, and an operating method thereof for interfacing with law enforcement authority to allow remote shut down of the vehicle by law enforcement when it is necessary to do so.

Another object of the present invention is to provide a vehicle electronic licensing terminal, and an operating method thereof for interfacing with law enforcement authority to provide a means for disabling the vehicle remotely by the local vehicle administration when it is necessary to do so.

Another object of the present invention is to provide a vehicle electronic licensing terminal, and an operating method thereof for interfacing with a local parking authority to provide vehicle licensing, and other information for efficient administration of parking permits, payments and other transactions connected with parking.

Another object of the present invention is to provide a vehicle electronic licensing terminal, and an operating method thereof for interfacing with toll collection and enforcement authority to provide vehicle licensing, and other information for efficient administration of toll permits, payments, and other transactions connected with toll roads.

Another embodiment of the present invention is to provide a method for electronic vehicle licensing wherein licensing information is encoded by a licensing authority in a programmable Vehicle Identification Module for slottable placement in the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein licensing renewal and other transactions involving the licensing authority may be carried out remotely on the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein licensing renewal and other transactions involving the licensing authority may be carried out remotely on the electronic vehicle licensing terminal and wherein the licensing authority can further communicate vehicle related transactions to the motorist via the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein licensing renewal and other transactions involving the licensing authority may be carried out remotely on the electronic vehicle licensing terminal and wherein the licensing authority can further communicate vehicle related transactions to a motorist via the electronic vehicle licensing terminal and wherein the motorist can further make a responsive communication back to the licensing authority.

Another embodiment of the present invention is to provide a method for electronic vehicle licensing wherein licensing information is encoded by a licensing authority in a programmable Vehicle Identification Module for slottable placement in the electronic vehicle licensing terminal and wherein law enforcement can communicate with the electronic vehicle licensing terminal via a wireless communication module of the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein law enforcement can interface with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein toll collection and enforcement authorities can communicate with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein toll collection and enforcement authorities can interface with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein parking authorities can communicate with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein parking authorities can interface with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein premises security authorities can communicate with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein premises security authorities can interface with the electronic vehicle licensing terminal.

Another embodiment of the present invention is to provide a method for electronic vehicle licensing wherein licensing information is encoded by a licensing authority in a programmable Vehicle Identification Module for slottable placement in the electronic vehicle licensing terminal and wherein licensing authorities can programmable disable the vehicle from a remote location.

In order to accomplish the foregoing objective, a mobile vehicle electronic licensing terminal associated with an embodiment of the present invention may include a programmable Vehicle identification Module (VIM); a wireless communication unit; and a controller connected to the VIM and the wireless communication units to support communication between the mobile terminal and the motor licensing authority.

In order to accomplish the foregoing objective, an operating method of a VIM electronic licensing terminal associated with embodiment of the present invention may include detecting an active state of the VIM; and performing a service requested by the user through the VIM.

The operating method of the mobile vehicle electronic licensing terminal associated with embodiment of the present invention may further include providing a menu to implement a specific application.

### BRIEF DESCRIPTION OF DRAWINGS

FIG. 1 is a block diagram illustrating a mobile vehicle electronic licensing terminal associated with an embodiment of the present invention;

### DETAILED DESCRIPTION OF THE PREFERRED EMBODIMENTS

Hereinafter, a mobile vehicle electronic licensing terminal associated with the present invention will be described in more detail with reference to the accompanying drawings. A suffix “module” or “unit” used for constituent elements disclosed in the following description is merely intended for easy description of the specification, and the suffix itself does not give any special meaning or function. Therefore, it should be noted that the suffix “module” or “unit” may be interchangeably used each other. As used herein, “vehicle” or “car” may be used interchangeably. It is understood that this invention may be used in any vehicle, including motorbikes and trucks and other motorized equipment subject to the authority of a vehicle licensing office.

A terminal can be implemented in various forms. A terminal disclosed herein may include vehicle electronic licensing terminals being a stand alone device or integrated into in-car electronics such as a vehicle navigation system, an in-car digital TV/video system.

In the following description, it is assumed and described that the terminal is a vehicle electronic licensing terminal. However, it would be easily understood by those skilled in the art that a configuration according to the following description may be applicable to other form factors.

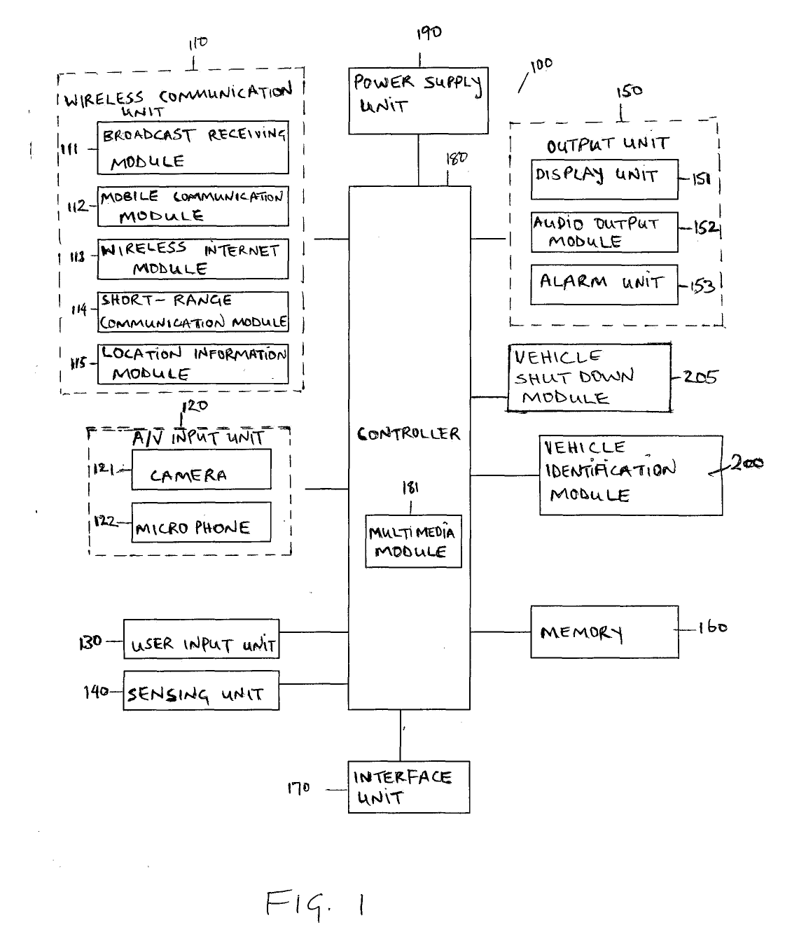

FIG. 1 is a block diagram illustrating a mobile vehicle electronic licensing terminal associated with an embodiment of the present invention.

The mobile vehicle electronic licensing terminal 100 may include a wireless communication unit 110, an Audio/Video (A/V) input unit 120, and a user input unit 130, a sensing unit 140, an output unit 150, a memory 160, an interface unit 170, a controller 180, a power supply unit 190, and the like. However, the constituent elements as illustrated in FIG. 1 are not necessarily required, and the mobile vehicle electronic licensing terminal may be implemented with greater or less number of elements than those illustrated elements.

Hereinafter, the constituent elements will be described in sequence.

The wireless communication unit 110 typically includes one or more modules allowing radio communication between the mobile vehicle electronic licensing terminal 100 and a wireless communication system, or allowing radio communication between radio communication of the mobile vehicle electronic licensing terminal 100 and a network, such as a local police network, a toll gate network, a parking network, a motor vehicle licensing network in which the mobile vehicle electronic licensing terminal 100 is located. For example, the wireless communication unit 110 may include a broadcast receiving module 111, a mobile communication module 112, a wireless Internet module 113, a short-range communication module 114, a location information module 115, and the like.

The broadcast receiving module 111 receives broadcast signals and/or broadcast associated information from an external broadcast management server through a broadcast channel. The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the mobile vehicle electronic licensing terminal 100. The broadcast associated information may mean information regarding a broadcast channel, a broadcast program, a broadcast service provider, and the like. The broadcast signal may include a TV broadcast signal, a radio broadcast signal and a data broadcast signal as well as a broadcast signal in a form that a data broadcast signal is combined with the TV or radio broadcast signal.

On the other hand, the broadcast associated information may also be provided through a mobile communication network, and in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may receive a broadcast signal using various types of broadcast systems. In particular, the broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 111 is, of course, configured to be suitable for every broadcast system that provides a broadcast signal as well as the above-mentioned digital broadcast systems.

The broadcast signal and/or broadcast-associated information received through the broadcast receiving module 111 may be stored in the memory 160.

The mobile communication module 112 transmits and/or receives a radio signal to and/or from at least one of a base station, an external terminal and a server over a mobile communication network. Here, the radio signal may include a voice call signal, a video call signal and/or various types of data according to text and/or multimedia message transmission and/or reception.

The wireless Internet module 113 means a module for supporting wireless Internet access. The wireless Internet module 113 may be built-in or externally installed to the mobile vehicle electronic licensing terminal 100. Here, it may be used a wireless Internet access technique including a WLAN (Wireless LAN), Wi-Fi, Wibro (Wireless Broadband), Wimax (World Interoperability for Microwave Access), HSDPA (High Speed Downlink Packet Access), and the like.

The short-range communication module 114 is a module for supporting a short-range communication. Here, it may be used a short-range communication technology including Bluetooth, Radio Frequency IDentification (RFID), Infrared Data Association (IrDA), Ultra WideBand (UWB), ZigBee, and the like.

The location information module 115 is a module for checking or acquiring a location of the vehicle electronic licensing terminal, and there is a Global Positioning System (GPS) module as a representative example. According to current technologies, the GPS module calculates spaced-apart distance information and accurate time information from three or more satellites and then applies trigonometry to the calculated information, thereby accurately calculating current position information based on latitude, longitude, and height. At present, there is widely used a method of calculating position and time information using three satellites and correcting an error of the calculated position and time information using another satellite. Furthermore, the GPS module can calculate speed information by continuously calculating a current position in real time.

On the other hand, the A/V (audio/video) input unit 120 receives an audio or video signal, and the A/V (audio/video) input unit 120 may include a driving camera 121, such as back-up camera, and a microphone 122. The camera 121 processes an image frame, such as still picture or video, obtained by an image sensor in a video or image capturing mode. The processed image frame may be displayed on a display unit 151.

The image frames processed by the camera 121 may be stored in the memory 160 or transmitted to an external device through the wireless communication unit 110. Two or more cameras 121 may be provided according to the use environment of the vehicle electronic licensing terminal.

The microphone 122 receives an external audio signal through a microphone in a recording mode, a voice recognition mode, and the like, and processes the audio signal into electrical voice data. The processed voice data may be converted and outputted into a format that is transmittable to a vehicle licensing base station through the communication module 112 of the electronic vehicle licensing terminal. The microphone 122 may implement various types of noise canceling algorithms to cancel noise generated in a procedure of receiving the external audio signal.

The user input unit 130 may generate input data to control an operation of the terminal 100. The user input unit 130 may be configured by including a keypad, a dome switch, a touch pad (pressure/capacitance), a jog wheel, a jog switch, and the like. Particularly, when the touch pad forms an interlayer structure together with a display unit 151 which will be described later, it may be called a touch screen.

The sensing unit 140 detects a current status of the mobile vehicle electronic licensing terminal 100 such as an opened or expired state of the mobile vehicle electronic licensing terminal 100, a location of the mobile vehicle electronic licensing terminal 100, an orientation of the mobile vehicle electronic licensing terminal 100, and the like, and generates a sensing signal for controlling the operation of the mobile vehicle electronic licensing terminal 100. For example, when the mobile vehicle electronic licensing terminal 100 is in an expired state as a result of failure to renew driver's license or vehicle license, the sensing unit may sense expired state or alert. Furthermore, the sensing unit 140 takes charge of a sensing function associated with whether or not power is supplied from the power supply unit 190, or whether or not an external device is coupled to the interface unit 170. On the other hand, the sensing unit 140 may include a proximity sensor 141. It will be described later in association with a touch screen.

The interface unit 170 performs a role of interfacing with all external devices connected to the mobile vehicle electronic licensing terminal 100. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

In a preferred embodiment, the interface unit 170 can also perform a role of interfacing with an external device operated by law enforcement, parking enforcement, toll enforcement or motor vehicle authority.

In another preferred embodiment, the interface unit 170 may be connected to an external device such as a computer for paying fines, renewing licenses and communicating insurance information with the motor vehicle authority.

Here, the identification module may be configured as a chip for storing various information required to authenticate an authority for using the mobile vehicle electronic licensing terminal 100, which may include a Vehicle Identity Module (VIM), and the like. Also, the device provided with the identification module (hereinafter, referred to as identification device) may be implemented in the type of a smart card. Hence, the identification device can be coupled to the mobile vehicle electronic licensing terminal 100 via a port. The interface units 170, 175 may receive data or power from an external device and transfer the received data or power to each constituent element in the mobile vehicle electronic licensing terminal 100, or transmit data within the mobile vehicle electronic licensing terminal 100 to the external device.

Also, the interface unit 170 may serve as a path for power to be supplied from an external cradle to the mobile vehicle electronic licensing terminal 100 when the portable terminal 100 is connected to the external cradle, or as a path for transferring various command signals inputted from the cradle by the user to the mobile vehicle electronic licensing terminal 100. Such various command signals or power inputted from the cradle may be operated as signals for recognizing that the mobile vehicle electronic licensing terminal 100 has accurately been mounted on the cradle.

Typically the VIM 200 contains vehicle registration information, personal information, vehicle ownership information, permits, restrictions and the like, including driver's license information, vehicle license information, ownership information, insurance information, tickets, alerts. The VIM 200 is typically given to the driver by the Motor Vehicle Authority in lieu of Registration cards to be slotted into the vehicle electronic licensing terminal.

The output unit 150 is configured to provide an output for audio signal, video signal, or alarm signal, and the output unit 150 may include the display unit 151, an audio output module 152, an alarm unit 153, a haptic module 154, and the like.

The display unit 151 may display (output) information processed in the mobile vehicle electronic licensing terminal 100. For example, when the mobile vehicle electronic licensing terminal 100 is in “license about to expire mode,” the display unit 151 may display a User Interface (UI) or a Graphic User Interface (GUI) associated with a registration renewal. The display unit may also be color coded as in green for “no violations,” amber for “warnings” and red for “serious or vehicle disabling violations” and display a User Interface (UI) or a Graphic User Interface (GUI) associated with such states. When the mobile vehicle electronic licensing terminal 100 is in image capturing mode, the display unit 151 may display a captured image and/or received image, a UI or GUI.

On the other hand, as described above, in case where the display unit 151 and the touch pad form an interlayer structure to constitute a touch screen, the display unit first display unit 151 may be used as an input device in addition to an output device. The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display. Some of those displays may be configured with a transparent type to allow viewing of the exterior through the display unit, which may be called transparent displays. An example of the typical transparent displays may include a transparent LCD (TOLED), and the like. The display unit 151 may be implemented in two or more in number according to a configured aspect of the mobile vehicle electronic licensing terminal 100. For example, an external display unit (not shown) and an internal display unit (not shown) may be simultaneously provided on the mobile vehicle electronic licensing terminal 100. The touch screen may be configured to detect a touch input pressure as well as a touch input position and area.

The audio output module 152 may output audio data received from the wireless communication unit 110 or stored in the memory 160, in a data-receiving mode, a data transmission mode, a recording mode, a voice recognition mode, a broadcast reception mode, and so on. The audio output module 152 may output audio signals relating to functions performed in the portable terminal 100, e.g., sound alarming a violation or speeding alert or approaching toll gate alert and so on. The audio output module 152 may include a receiver, a speaker, a buzzer, and so on.

The alarm 153 outputs signals notifying occurrence of events from the portable terminal 100. The events occurring from the mobile vehicle electronic licensing terminal may include alert received, message received, key signal input, touch input, and so on. The alarm 153 may output not only video or audio signals, but also other types of signals such as signals notifying occurrence of events in a light flashing manner. When an alert or message is received from the motor vehicle administration authority, the alarm 153 may output a beep to notify this. Otherwise, when a key signal is inputted, the alarm 153 may output a beep as a feedback to the inputted key signal. Through the foregoing beep output, the user can recognize an event occurrence. The signal for notifying an event occurrence may be also outputted through the display unit 151 or the audio output module 152.

The memory 160 may store a program for processing and controlling of the controller 180, or may temporarily store input/output data (e.g., vehicle licensing data, vehicle safety data, vehicle maintenance schedule data, messages, still images, video and the like). Also, the memory 160 may store data related to various patterns of beeps and audio output upon a touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile vehicle electronic licensing terminal 100 may manage a web storage which performs a storage function of the memory 160 on the Internet.

The controller 180 typically controls an overall operation of the electronic licensing terminal 100, including the vehicle shutdown or disabling module 205. For example, the controller 180 performs the control and processing associated with data communications, privacy issues such as password enablement, biometrics enablement, keyless entry, keyless starting, and VIM card management modules, and the like. Furthermore, the controller 180 may include a multimedia module 181 for reproducing multimedia files. The multimedia module 181 may be implemented in the controller 180, or may be implemented separately from the controller 180.

The controller 180 can perform a pattern recognition processing so as to recognize handwriting or drawing input performed on the touch screen as a text or image.

The power supply unit 190 provides power required by various components under the control of the controller 180. The provided power may be internal power, or external power thereof.

The vehicle shutdown module 205 optionally provides the motor vehicle authority or the law enforcement agency to remotely shut down the vehicle whenever it is appropriate to do so. One means of shutting down the vehicle is to programmably interface the terminal with the vehicle's ECU to disable a key component of the vehicle such as ignition, fuel pump, or the like.

Various embodiments described herein may be implemented in a computer-readable medium using, for example, software, hardware, or some combination thereof.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

It is understood that the mobile vehicle electronic licensing terminal may contain other modules such as vehicle tracking modules usable by a leasing or rental authority; or a security licensing module which allows security gates to open only for vehicles possessing an approved electronic licensing terminal.

In a preferred embodiment, the electronic licensing terminal 100 further comprises a vehicle security and/or vehicle disabling module. In one embodiment, authentication information must be entered by the driver in order for the vehicle to start. In another embodiment, the electronic licensing terminal can programmably interface with the Engine Control Module or Electronic Control Unit for both vehicle security and vehicle disabling.

In the above, a mobile vehicle electronic licensing terminal associated with the present invention has been described from a viewpoint of function-based elements. Hereinafter, a mobile vehicle electronic licensing terminal associated with the present invention will be described from a viewpoint of appearance-based elements. However, the present invention is not limited to any form of appearance or form factor.

The mobile vehicle electronic licensing terminal 100 according to the present invention may include a first body comprising the output display and a backing or housing for implementing the electronic components, wherein the output display also comprises the user input interface in a touch screen format. A terminal according to the touch screen type adaptable for mounting in the central console of a vehicle or elsewhere within easy rich of a vehicle operator can be easily understood with no additional explanation by those skilled in the art, and thus the detailed description thereof will be omitted.

The mobile vehicle electronic licensing terminal 100 is primarily operated in a in an open configuration when the ignition is on and in a standby mode when the ignition is turned off. On the other hand, mobile vehicle electronic licensing terminal 100 may also be rechargeably battery powered and may be switched on and off by the user.

In a preferred embodiment, a case (casing, housing, cover, etc.) forming an appearance of the output display unit is formed at the rear of the output display unit. Various electronic components are built into the case. The cases may be formed by injection-molding a synthetic resin or may be also formed of a metal material such as stainless steel (STS), titanium (Ti), or the like.

A display unit 151, an audio output module 152, and a camera 121 or user input unit 130 may be arranged on the top portion of the case.

The display unit 151 has been described in association with FIG. 1 and thus the detailed description thereof will be omitted for the sake of brevity of this specification.

The LED unit 152 may be implemented in the form of a speaker.

The camera 121 may be implemented suitably to capture still or moving images for the user or the like. In a preferred embodiment, the camera 121 may be mounted elsewhere on the vehicle such as a back up camera.

Additionally, the user input unit may be implemented with a dome switch or touch pad capable of receiving a command or information by a user's push or touch manipulation, or may be also implemented using a wheel or jog method for rotating a key or using a method of manipulating a joystick, or the like.

From a functional viewpoint, the user input unit 130 is provided to input commands such as start, end, scroll, or the like, as well as numerals or characters, symbols, or the like. The user input unit 130 may include a so-called soft key used in conjunction with icons displayed on the display unit 151, and navigation keys (mainly, configured with four directional keys and center key) for directing and confirming the direction. Furthermore, the user input may also operate as a hot-key for activating a special function in the vehicle electronic licensing terminal.

The microphone 122 may be implemented in a suitable form to receive a user's voice, other sounds, or the like.

The interface unit 170 serves as a path allowing the mobile vehicle electronic licensing terminal 100 associated with the present invention to exchange data with external devices. In the above, the interface unit 170 has been described in association with FIG. 1, and thus the detailed description thereof will be omitted.

The power supply unit 190 for supplying power to the mobile vehicle electronic licensing terminal 100 is mounted at the back or side of the terminal. It can be hard wired to the vehicle's electrical system to draw power directly from the battery or it can be provided with a Cigarette lighter plug for drawing power via said plug. The power supply unit 190 may be detachably coupled with the mobile vehicle electronic licensing terminal 100 for charging or the like as a battery.

An audio output unit 152 may be additionally disposed on the front or side of the terminal 100. The audio output unit 152 can implement a stereo function, and may be also used to implement a speaker.

Furthermore, in addition to an antenna for wireless communication, an antenna for receiving broadcast signals may be disposed on a side of the terminal. The antenna may be provided so as to be pulled out from the side of the unit.

A terminal 100 as illustrated in FIG. 1 may be configured to be operated in a communication system capable of transmitting data via frames or packets including a wireless or wired communication system and a satellite-based communication system.

A communication system may use different wireless interfaces and/or physical layers. For example, a wireless that can be used by a communication system may include Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), and the like. However, it is apparent that the present invention may be applicable to all kinds of communication systems including a CDMA wireless communication system.

A CDMA communication system is configured to be connected to a plurality of terminals 100, a plurality of base stations (BSs), a plurality of base station controllers (BSCs), and a mobile switching center (MSC). The MSC is configured to be connected to a public switched telephone network (PSTN), and also configured to be connected to BSCs. The BSCs may be connected to BSs in pairs through a backhaul line. The backhaul line may be provided with at least one of E1/T1, ATM, IP, PPP, Frame Relay, HDSL, ADSL, and xDSL. Accordingly, a plurality of BSCs may be included in a system.

Each BS may include at least one sector, and each sector may include an omni-directional antenna or an antenna directing a specific radial direction from the BS. Alternatively, each sector may include two or more antennas in various shapes. Each BS may also be configured to support allocation of a plurality of frequencies in which each frequency allocation has a specific spectrum (for example, 1.25 MHz, 5 MHz, etc.).

An intersection between the sector and the frequency allocation may be referred to as a CDMA channel. The BSs may also be referred to as Base Station Transceiver Subsystems (BTSs). In this case, the term “base station” may refer to a combination of one BSC and at least one BS. The base station may also designate a “cell site”. Alternately, each of the sectors with respect to a specific BS may be referred to as a plurality of cell sites.

A Broadcasting Transmitter (BT) serves to transmit a broadcast signal to the terminals 100 operating in the system. The broadcast receiving module 111 illustrated in FIG. 1 is provided in the terminal 100 so as to receive the broadcast signal transmitted by the BT.

Multiple Global Positioning System (GPS) satellites serve to detect a position of at least one of the multiple terminals 100. The GPS module 115 illustrated in FIG. 1 cooperates with the satellites so as to obtain desiring position information. Here, the module 115 can track the position using all techniques allowing to track positions, as well as the GPS tracking technology. Also, at least one of the GPS satellites may handle satellite DMB transmission alternatively or additionally.

Among typical operations of a wireless communication system, a BS serves to receive reverse link signals from various terminals 100. At this time, the terminal 100 is transmitting and/or receiving a message or executing other communication operations. Each reverse link signal received by a specific base station is processed within the specific BS. Data generated resulting from the processing is transmitted to the connected BSC. The BSC serves to allocate a communication resource and manage mobility, including systemization of soft handoffs between the BSs. Also, the BSC transmits the received data to the MSC, and then the MSC provides an additional transmission service so as to be connected to a PSTN. Similarly, the PSTN is connected to the MSC and the MSC is connected to the BSCs, and the BSCs control the BSs so as to transmit forward link signals to the terminals 100.

A mobile vehicle electronic licensing terminal according to an embodiment of the present invention may include a controller 180, and one or two radio frequency (RF) units, and a Vehicle Identification Module (VIM). In other words, the present invention is basically formed with a single chipset structure.

Furthermore, according to an embodiment of the present invention, the foregoing method may be implemented as codes readable by a computer on a medium written by the program. The computer-readable media includes all types of recording devices in which data readable by a computer system can be stored. Examples of the computer-readable media may include ROM, RAM, CD-ROM, magnetic tape, floppy disk, and optical data storage device, and the like, and also include a device implemented via a carrier wave (for example, a transmission via the Internet). The computer may include the controller 180 of the mobile vehicle electronic licensing terminal 100.

The configurations and methods according to the above-described embodiments are to the foregoing terminal, and all or part of each embodiment may be selectively combined and configured to make various modifications thereto.

What is claimed:

1. A mobile vehicle electronic licensing terminal comprising a programmable Vehicle identification Module (VIM); a wireless communication unit; and a controller connected to the VIM and the wireless communication units to support communication between the mobile terminal and the motor licensing authority, and an operating method thereof for supporting vehicle related transactions between a motorist and a motor vehicle administration authority.

2. The mobile vehicle electronic licensing terminal of claim 1, and an operating method thereof for performing licensing renewal remotely and electronically communicating with the motor vehicle administration authority.

3. The mobile vehicle electronic licensing terminal of claim 1, and an operating method thereof for interfacing with law enforcement authority to provide vehicle licensing, insurance, emissions, and other law enforcement information such as unpaid tickets, notifications, violations, substance abuse violations, restrictions, and the like.

4. The mobile vehicle electronic licensing terminal of claim 1, and an operating method thereof to provide a vehicle electronic licensing terminal, and an operating method thereof for interfacing with law enforcement authority to allow remote shut down of the vehicle by law enforcement.

5. The mobile vehicle electronic licensing terminal of claim 1 and an operating method thereof for interfacing with law enforcement authority to provide a means for disabling the vehicle remotely by the local vehicle administration when it is necessary to do so.

6. The mobile vehicle electronic licensing terminal of claim 1 and an operating method thereof for interfacing with a local parking authority to provide vehicle licensing, and other information for efficient administration of parking permits, payments and other transactions connected with parking.

7. The mobile vehicle electronic licensing terminal of claim 1 and an operating method thereof for interfacing with toll collection and enforcement authority to provide vehicle licensing, and other information for efficient administration of toll permits, payments, and other transactions connected with toll roads.

8. The mobile vehicle electronic licensing terminal of claim 1 and an operating method thereof for interfacing with a local parking authority to provide vehicle licensing, and other information for efficient administration of parking permits, payments and other transactions connected with parking

9. A method for electronic vehicle licensing wherein licensing information is encoded by a licensing authority in a programmable Vehicle Identification Module for slottable placement in a electronic vehicle licensing terminal.

10. The method of claim 9, wherein licensing renewal and other transactions involving the licensing authority may be carried out remotely on the electronic vehicle licensing terminal.

11. The method of claim 10, wherein the licensing authority can further communicate vehicle related transactions to the motorist via the electronic vehicle licensing terminal.

12. The method of claim 11, wherein the motorist can further make a responsive communication back to the licensing authority.

13. The method of claim 9, wherein law enforcement can communicate with the electronic vehicle licensing terminal via a wireless communication module of the electronic vehicle licensing terminal.

14. The method of claim 9, wherein law enforcement can interface with the electronic vehicle licensing terminal.

15. The method of claim 9, wherein toll collection and enforcement authorities can communicate with the electronic vehicle licensing terminal.

16. The method of claim 9, wherein toll collection and enforcement authorities can interface with the electronic vehicle licensing terminal.

17. The method of claim 9, wherein parking authorities can communicate with the electronic vehicle licensing terminal.

18. The method of claim 9, wherein parking authorities can interface with the electronic vehicle licensing terminal.

19. The method of claim 9, wherein premises security authorities can communicate with the electronic vehicle licensing terminal.

20. The method of claim 9, wherein licensing authorities can programmable disable the vehicle from a remote location.
